(19) United States
(12) Patent Application Publication
(10) Pub. No.: US 2004/0042936 A1
(43) Pub. Date: Mar. 4, 2004

(54) Cross-wave sonicator

(76) Inventor: Koukichi Ido, Chiba-city (JP)

Correspondence Address: WENDEROTH, LIND & PONACK, L.L.P., 2033 K STREET N. W., SUITE 800, WASHINGTON, DC, 20006-1021, US

(21) Appl. No.: 10/440,253

(22) Filed: May 19, 2003

(30) Foreign Application Priority Data
Aug. 28, 2002 (JP) U2002-5444

(51) Int. Cl. B06B 1/00

(52) U.S. Cl. 422/128

(57) ABSTRACT

The cross-wave sonicator has a simple structure and yet can achieve disintegration of cells or tissues so as to remove DNA, RNA or other substances therefrom. The sonicator has a processing tank provided with side walls, the lower portions of which are bent inward to form inclined walls respectively. Ultrasonic wave transducers are attached on external surfaces of the inclined walls to radiate ultrasonic waves such that they intersect orthogonally with each other within the processing tank to generate high energy around samples to be treated, thus achieving sonication of the samples.

### BACKGROUND OF THE INVENTION

1. Field of the Invention

The present invention relates to a sonicator for sonicating (disintegrating) cells or tissues with ultrasonic waves so as to remove DNA, RNA or other substances therefrom.

2. Description of the Related Art

Various studies have been made recently with development of biotechnology, and sonicators are utilized in operations of removing DNA, RNA or other substances from cells and tissues. In these operations, it is desirable for operators to carry out sonication of samples infected with BSE or other pestiferous diseases with the samples being sealed in tubes.

Schemes of conventional sonicators will be explained referring to FIGS. 4 and 5. FIG. 4 shows a sonication method in which a sample 82 contained in a tube 80 is disintegrated by bringing an ultrasonic wave transducer 81 into direct contact with the sample. FIG. 5 shows a method in which a sample 82 sealed in a plastic vessel 84 is as such exposed to an ultrasonic wave from an ultrasonic wave transducer 83.

Of these two methods described above, the former method (direct exposure) has been predominantly used. Because the vessels including the tube 80 are made of plastics, and an ultrasonic wave has the intrinsic property that it can hardly penetrate flexible materials, so that the energy of the ultrasonic wave is halved when it propagates through such plastic vessels.

In the method shown in FIG. 4, it is difficult to operate under aseptic condition, since the ultrasonic wave transducer 81 is brought into direct contact with the sample 82. Besides, the greater the number of samples is, the poorer becomes the workability and the higher becomes the liability of contamination.

Meanwhile, in the method shown in FIG. 5, an ultrasonic wave is radiated in one direction to suffer a great loss of energy, disadvantageously.

### SUMMARY OF THE INVENTION

The present invention is proposed with a view to solving-the problems inherent in the prior art examples described above. According to one aspect of the present invention, the cross-wave sonicator is provided with a processing tank having side walls, the lower portions of which are bent inward to form inclined walls respectively. The sonicator is also provided with ultrasonic wave transducers attached onto external surfaces of the inclined walls, which radiate ultrasonic waves such that they intersect orthogonally with each other within the processing tank to generate high energy around samples to be treated, thus achieving sonication of the samples.

According to another aspect of the present invention, the inclined walls are designed to have an angle of 45° with respect to the side walls, and the ultrasonic wave transducers are attached orthogonally to the inclined walls so that ultrasonic waves generated from the transducers intersect orthogonally with each other.

Other aspects and advantages of the invention will become apparent from the following description, taken in conjunction with the accompanying drawings illustrated by way of examples the principles of the invention.

### BRIEF DESCRIPTION OF THE DRAWINGS

The invention together with the objects and advantages thereof may best be understood by reference to the following description of the presently preferred embodiments together with the accompanying drawings in which:

FIG. 1 is a schematic front view of a cross-wave sonicator according to one embodiment of the present invention;

FIG. 2 is a plan view of the cross-wave sonicator shown in FIG. 1;

FIG. 3 is an explanatory drawing showing actions of the cross-wave sonicator shown in FIG. 1;

FIG. 4 is an explanatory drawing showing an example of prior art sonicator; and

FIG. 5 is an explanatory drawing showing another example of prior art sonicator.

### DETAILED DESCRIPTION OF THE PREFERRED EMBODIMENTS

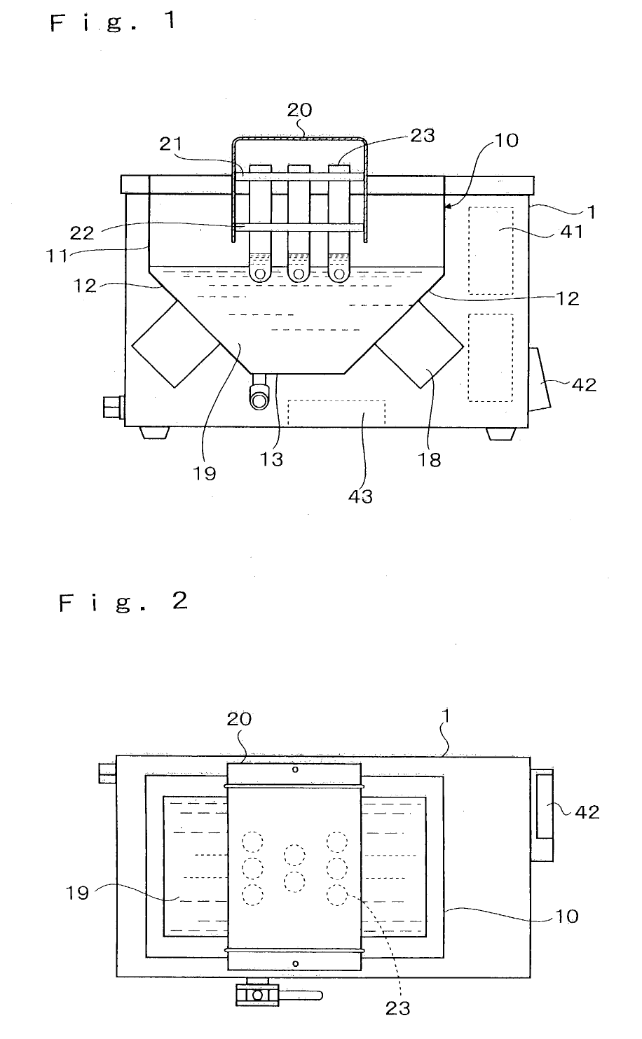

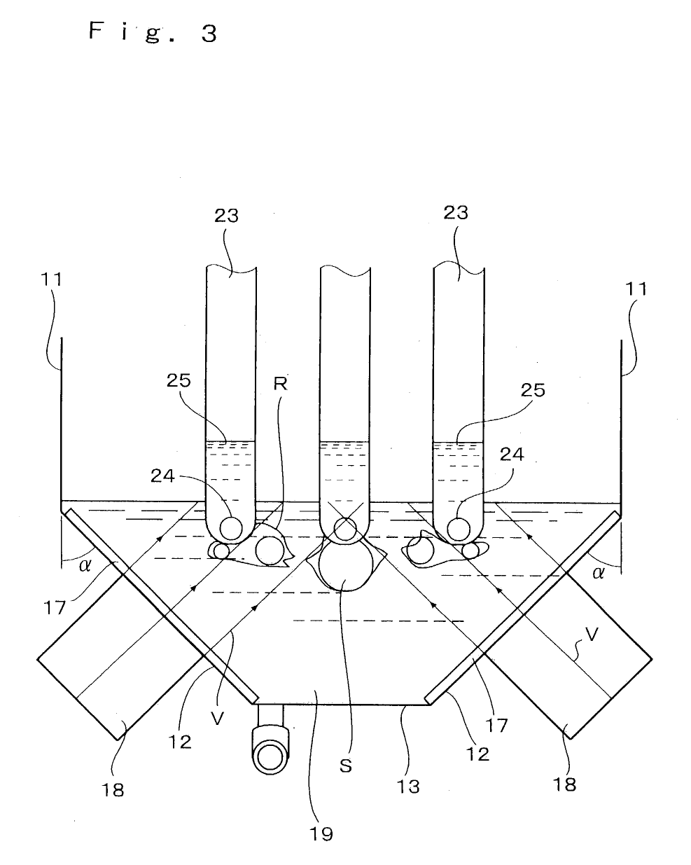

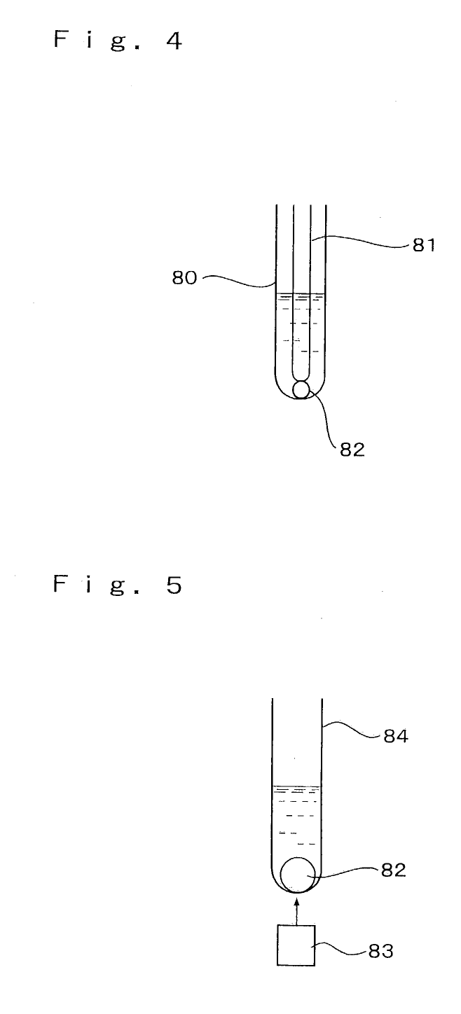

The cross-wave sonicator according to one embodiment of the present invention will be described referring to the attached drawings. FIG. 1 is a schematic front view of the cross-wave sonicator; FIG. 2 is a plan view of the cross-wave sonicator; FIG. 3 is an explanatory drawing showing actions of the cross-wave sonicator.

The cross-wave sonicator 1 contains a processing tank 10 for carrying out sonication and also contains a pair of oscillators 41, a cooling fan 43 and an operation panel 42.

The processing tank 10 is a substantially rectangular water bath and is designed to have a structure such that a container 20 to be described later can be mounted on top of it. A pair of vertical side walls 11 of the processing tank 10 are bent inward at around the middle by an angle α to form a pair of inclined walls 12 respectively. The lower extremity of each inclined wall 12 connects to a horizontal bottom plate 13. The angle α is most preferably 45° as exemplified in this embodiment. However, the angle α is not limited to 45°.

An ultrasonic wave transducer 18 is attached to the external surface of each inclined wall 12 to be orthogonal to it. A diaphragm 17 is located on the internal side of each inclined wall 12.

While a pair of inclined walls 12 are formed in the right and left side walls 11 in this embodiment, the front and back side walls may also have inclined walls. In this case, the processing tank 10 has four inclined walls 12, and four ultrasonic wave transducers 18 are attached to these four inclined walls, respectively.

The container 20 is a rack for setting tubes 23 on the processing tank 10 and has a pair of holders 21 and 22 secured therein. The holders 21 and 22 hold the tubes 23 with the lower end portions thereof being immersed in water 19. In this embodiment, the holders hold eight tubes 23. This container 20 is positioned at the center of the processing tank 10 where samples can be exposed most fully to ultrasonic waves.

Actions of the cross-wave sonicator of this embodiment having the constitution as described above will be described.

First, tubes 23 are set in the holders 21 and 22 of the container 20, and the container 20 is mounted on the processing tank 10. The tubes 23 each contain an aqueous solution 25 and a sample 24 to be sonicated. The lower end portions of the tubes 23 are immersed in water 19 so as to allow transmission of ultrasonic waves thereto with the aid of water.

Then, the oscillators 41 are actuated to operate the ultrasonic wave transducers 18 and generate ultrasonic waves. The ultrasonic waves are intensified when they go through the diaphragms 17 respectively to progress further toward the tubes 23.

It should be noted here that the ultrasonic waves V passed through the pair of diaphragms 17 progress orthogonal to the respective inclined walls 12, as shown in FIG. 3, so that the ultrasonic wave radiated from one ultrasonic wave transducer 18 intersects orthogonally with the ultrasonic wave radiated from the other ultrasonic wave transducer 18. The intersection of the ultrasonic waves is preset around the water surface at the center of the processing tank 10, and tubes 23 are arranged as described above around the intersection area.

The ultrasonic waves V progress through the water 19 in the processing tank 10 to reach the tubes 23, and they progress further through the aqueous solution 25 to reach finally the sample 24 in each tube 23 and sonicate it.

In FIG. 3, R means the range where cavitation was caused by the ultrasonic waves, and S means the range where cavitation occurred intensively.

The sonicator according to this embodiment exhibits the following effects.

In the cross-wave sonicator 1, since the ultrasonic waves radiated through the right and left diaphragms 17 intersect orthogonally with each other to impinge upon the samples 24 in the tubes 23, the ultrasonic energy is intensified. Thus, the sonicator 1 can effectively perform sonication of the samples 24 even if the tubes 23 or vessels are made of a flexible plastic material.

As has been described heretofore, the cross-wave sonicator of the present invention outputs high ultrasonic energy in spite of its simple structure and can achieve sonication of samples efficiently.

It should be apparent to those skilled in the art that the present invention may be embodied in many other specific forms without departing from the spirit or scope of the invention.

What is claimed is:

1. A cross-wave sonicator comprising:
a processing tank having side walls, the lower portions of which are bent inward to form inclined walls respectively; and
ultrasonic wave transducers attached onto external surfaces of the inclined walls and radiate ultrasonic waves such that they intersect orthogonally with each other within the processing tank to generate high energy around sample to be treated, thus achieving sonication of the samples.

2. The cross-wave sonicator according to claim 1, wherein the inclined walls are designed to have an angle of 45° with respect to the side walls, and the ultrasonic wave transducers are attached orthogonally to the inclined walls so that ultrasonic waves generated from the transducers intersect orthogonally with each other.
